(19) United States
(12) Patent Application Publication
(10) Pub. No.: US 2012/0314909 A1
(43) Pub. Date: Dec. 13, 2012

(54) SYSTEM AND METHOD FOR MAGNETIC RESONANCE ANGIOGRAPHY COORDINATED TO CARDIAC PHASE USING SPIN LABELING

(76) Inventor: Robert R Edelman, Highland Park, IL (US)

(21) Appl. No.: 13/157,201

(22) Filed: Jun. 9, 2011

(51) Int. Cl. G06K 9/00

(52) U.S. Cl. 382/107

(57) ABSTRACT

A system and method is provided for magnetic resonance angiography (MRA) that includes applying a labeling pulse sequence to a labeling region of a subject having a first portion of a vasculature extending through the labeling region to label spins moving within the labeling region and acquiring labeling data from labeled spins moving in the subject. The labeling data is analyzed to determine a velocity of the labeled spins and the velocity of the labeled spins is compared to a predetermined metric to determine when the subject is in a predetermined cardiac phase. When in a desired cardiac phase, an imaging pulse sequence is applied to an imaging region of the subject having a second portion of the vasculature extending through the imaging region to acquire medical imaging data from the imaging region. The imaging region is separate from labeling region.

### CROSS-REFERENCE TO RELATED APPLICATIONS

N/A

### FIELD OF THE INVENTION

The invention relates to a system and method for performing magnetic resonance angiography (MRA) and, more particularly, to a system and method for MRA that is coordinated with the cardiac cycle without the need for physiological monitoring systems and is not limited by traditional imaging-based mechanisms for monitoring cardiac phase.

### BACKGROUND OF THE INVENTION

When a substance such as human tissue is subjected to a uniform magnetic field (polarizing field B₀), the individual magnetic moments of the nuclear spins in the tissue attempt to align with this polarizing field, but precess about it in random order at their characteristic Larmor frequency. Usually the nuclear spins are comprised of hydrogen atoms, but other NMR active nuclei are occasionally used. A net magnetic moment M_{z} is produced in the direction of the polarizing field, but the randomly oriented magnetic components in the perpendicular, or transverse, plane (x-y plane) cancel one another. If, however, the substance, or tissue, is subjected to a magnetic field (excitation field B₁; also referred to as the radiofrequency (RF) field) which is in the x-y plane and which is near the Larmor frequency, the net aligned moment, M_{z}, may be rotated, or “tipped” into the x-y plane to produce a net transverse magnetic moment Mₜ, which is rotating, or spinning, in the x-y plane at the Larmor frequency. The practical value of this phenomenon resides in the signal which is emitted by the excited spins after the excitation field B₁ is terminated. There are a wide variety of measurement sequences in which this nuclear magnetic resonance (“NMR”) phenomenon is exploited.

When utilizing these signals to produce images, magnetic field gradients (Gₓ, G_{y}, and G_{z}) are employed. Typically, the region to be imaged experiences a sequence of measurement cycles in which these gradients vary according to the particular localization method being used. The emitted MR signals are detected using a receiver coil. The MRI signals are then digitized and processed to reconstruct the image using one of many well-known reconstruction techniques.

Magnetic resonance angiography (MRA) uses the NMR phenomenon to produce images of the human vasculature. There are three main categories of techniques for achieving the desired contrast for the purpose of MR angiography. The first general category is typically referred to as contrast enhanced (CE) MRA. The second general category is time-of-flight (TOF) MRA. The third general category is phase contrast (PC) MRA.

To perform CE MRA, a contrast agent, such as gadolinium, is injected into the patient prior to the magnetic resonance (MR) angiogram to enhance the diagnostic capability of the MR angiogram. While CE MRA is a highly effective means for noninvasively evaluating suspected vascular disease, the technique suffers from several additional drawbacks. First, the contrast agent that must be administered to enhance the blood vessel carries a significant financial cost. Second, contrast agents such as gadolinium have recently been shown to be causative of an often catastrophic disorder called nephrogenic systemic fibrosis (NSF). Third, CE MRA does not provide hemodynamic information, so that it is not always feasible to determine if a stenosis is hemodynamically significant. Fourth, the signal-to-noise ratio (SNR) and, therefore, spatial resolution is limited by the need to acquire data quickly during the first pass of contrast agent through a target vessel. For these reasons, there have been substantial efforts to move away from CE MRA imaging protocols in favor of non contrast-enhanced (NCE) MRA protocols.

Fortunately, TOF and PC MRA imaging techniques do not require the use of a contrast agent. The 3D TOF techniques were introduced in the 1980's and they have changed little over the last decade. The 3D TOF MRA techniques commonly used for cranial examinations and have not been replaced despite recent advances in time-resolved contrast-enhanced 3D MRA. An alternative technique known as pulsed arterial spin labeling (PASL) was first applied to image intracranial circulation years ago; however, image quality never approached that of 3D TOF and the method has had little clinical utility. Moreover, electrocardiographic (ECG) gating was required. The use of TOF MRA is generally limited to imaging of intracranial circulation, however, because of sensitivity to patient motion and flow artifacts.

Finally, phase contrast (PC) MRA is largely reserved for the measurement of flow velocities and imaging of veins. Phase contrast sequences are the basis of MRA techniques utilizing the change in the phase shifts of the flowing protons in the region of interest to create an image. Spins that are moving along the direction of a magnetic field gradient receive a phase shift proportional to their velocity. Specifically, in a PC MRA pulse sequence, two data sets with a different amounts of flow sensitivity are acquired. This is usually accomplished by applying gradient pairs, which sequentially dephase and then rephase spins during the sequence. The first data set is acquired using a “flow-compensated” pulse sequence or a pulse sequence without sensitivity to flow. The second data set is acquired using a pulse sequence designed to be sensitive to flow. The amount of flow sensitivity is controlled by the strength of the bipolar gradient pulse pair use in the pulse sequence because stationary tissue undergoes no effective phase change after the application of the two gradients, whereas the different spatial localization of flowing blood is subjected to the variation of the bipolar gradient. Accordingly, moving spins experience a phase shift. The raw data from the two data sets are subtracted to yield images that illustrate the phase change, which is proportional to spatial velocity. To perform PC MRA pulse sequences, a substantial scan time is generally required and the operator must set a velocity-encoding sensitivity, which varies unpredictably depending on a variety of clinical factors.

Regardless of the specific imaging technique used to acquire angiographic images (contrast enhanced or non contrast enhanced), it is often advantageous if not clinically necessary to coordinate images and, often more importantly, data acquisition, with the cardiac cycle. In the most common situation, a signal representing the cardiac cycle is acquired using a physiological monitoring system, such as an echocardiographic system (ECG) or other cardiac monitoring system, for example, even including plethysmographic or an MR-compatible stethoscope. Unfortunately, ECG or similar gating techniques are not always reliable given the electromagnetic interference produced by the MRI scanner, especially at high field strengths. On the other hand, while plethysmographic gating and an MR-compatible stethoscopes are insensitive to electromagnetic interference, they present their own drawbacks. MR-compatible stethoscopes, which detect acoustic signals representative of the cardiac cycle, require a device to be placed upon the patient's chest, which can interfere with imaging protocols and, generally, complicates the setup of the exam and implementation. Plethysmographic gating protocols fail if the peripheral circulation is poor due to vasoconstriction or atherosclerotic disease and, thus, can have limited clinical applicability.

Several approaches for cardiac gating without the use of additional, physiological monitoring systems have been developed. One such category is often referred to as “self-gating” because it uses information acquired using the medical imaging system to then gate the acquisition of medical imaging data using the imaging system. For example, navigator imaging protocols can be used to monitor the heart and identify and trigger imaging based on the cardiac cycle. However, navigator-based triggering or gating requires imaging data acquisition from the heart. Thus, the heart must be within the field of view to perform such navigator-based triggering or gating. Accordingly, such protocols are not useful, for instance, when imaging the peripheral arteries. Moreover, such navigator signals are sensitive to artifacts from breathing, bulk patient motion, and arrhythmias.

Another category of cardiac-gated imaging that does not require external physiological monitoring systems relies on the above-described PC techniques, which detect flow signals by subtraction of a flow-sensitive acquisition from one which is flow-insensitive. Unfortunately, beyond the potential issues of pulse sequence setup and data acquisition duration described above, PC-based techniques are highly sensitive to static magnetic field inhomogeneities and gradient-induced eddy currents. Moreover, PC-based techniques, generally, are highly sensitive to patient motion and are unsuitable for many clinical imaging applications that necessitate cardiac gating.

Therefore, it would be desirable to have a system and method for performing MRA that does not suffer from the drawbacks of each of the methods described above.

### SUMMARY OF THE INVENTION

The present invention provides a system and method for producing an angiogram with a magnetic resonance imaging (MRI) system that is coordinated with the cardiac phase of the subject being imaged without the need for external physiological monitoring systems. Furthermore, the present invention provides the ability to coordinate MRA images with the cardiac cycle without the limitations of traditional “self-gated” imaging techniques or the spatial limitations of other imaging-based coordination techniques, such as navigator-based coordination techniques. Specifically, the present invention uses concepts of arterial spin labeling to acquire labeling data from spins moving within the labeling region of the subject. The labeling data is analyzed to determine a velocity of the spins moving within the labeling region and a cardiac phase. This determination of cardiac phase is then used to acquire medical imaging data from an imaging region separate from the labeling region that is coordinated to the cardiac phase.

In accordance with one aspect of the invention, a method is provided for acquiring a magnetic resonance angiography (MRA) image of a portion of a vasculature of a subject using a magnetic resonance imaging system. The method includes applying a labeling pulse sequence to a labeling region of a subject having a first portion of a vasculature extending through the labeling region to label spins moving within the labeling region and acquiring labeling data from the labeled spins moving within the subject. The method also includes analyzing the labeling data to determine a velocity of the labeled spins and comparing the velocity of the labeled spins to a predetermined metric. Based on the comparison of the velocity of the labeled spins to the predetermined metric, the subject is determined to be in a predetermined cardiac phase. When the subject is in the predetermined cardiac phase, the method includes applying an imaging pulse sequence to an imaging region of the subject having a second portion of the vasculature extending through the imaging region. The imaging region is separate from labeling region. The method then includes acquiring medical imaging data from the imaging region of the subject and reconstructing an image of the second portion of the vasculature from the medical imaging data.

In accordance with another aspect of the invention, a non-transitive computer readable store medium is provided having stored thereon a set of instructions that, when executed by a computer system, cause the computer system to apply a labeling pulse sequence to a labeling region of a subject having a first portion of a vasculature to label spins moving within the labeling region. The instructions further cause the computer to acquire labeling data from labeled spins, analyze the labeling data to determine a velocity of the labeled spins moving within the subject, and compare the velocity of the labeled spins to a predetermined metric. Based on the comparison of the velocity of the labeled spins to the predetermined metric, a cardiac phase of the subject is determined. When the cardiac phase of the subject is a predetermined cardiac phase, the computer is caused to apply an imaging pulse sequence to an imaging region of the subject having a second portion of the vasculature extending therein. The imaging region is separate from the labeling region. The computer is further caused to acquire medical imaging data from the imaging region of the subject and reconstruct an image of the second portion of the vasculature from the medical imaging data.

In accordance with yet another aspect of the invention, a magnetic resonance imaging (MRI) system is provided that includes a magnet system configured to generate a polarizing magnetic field about at least a portion of a subject arranged in the MRI system, a plurality of gradient coils configured to apply a gradient field to the polarizing magnetic field, and a radio frequency (RF) system configured to apply an excitation field to the subject and acquire MR image data therefrom. The system also includes a computer system programmed to control the RF system and gradient coils according to a labeling module to perform a labeling pulse sequence to label moving spins in a first portion of a vasculature of a subject and acquire labeling data from the first portion of the vasculature of the subject or a region proximate to the first portion of the vasculature of the subject. The computer is also programmed to operate according to a threshold module to analyze the labeling data to determine a velocity of the moving spins, compare the velocity of the moving spins to a predetermined metric and, based on the comparison of the velocity of the moving spins to the predetermined metric, generate a trigger signal upon determining the subject is in a predetermined cardiac phase. The computer is programmed to also control the RF system and gradient coils, in response to the trigger signal, according to an imaging module to perform an imaging pulse sequence and acquire medical imaging data from a second portion of the vasculature of the subject that is separate from the first portion of the vasculature. The computer is programmed to reconstruct an image of the second portion of the vasculature from the medical imaging data.

The foregoing and other advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a block diagram of an MRI system for use with the present invention.

FIG. 2 is a schematic representation of a transceiver system for use with the MRI system of FIG. 1.

FIG. 3 is a flow chart of the steps performed in accordance with one exemplary implementation of the present invention.

FIGS. 4A and 4B are diagrams illustrating two pulse sequences performed by the MRI system of FIG. 1 in accordance with the present invention.

### DETAILED DESCRIPTION OF THE INVENTION

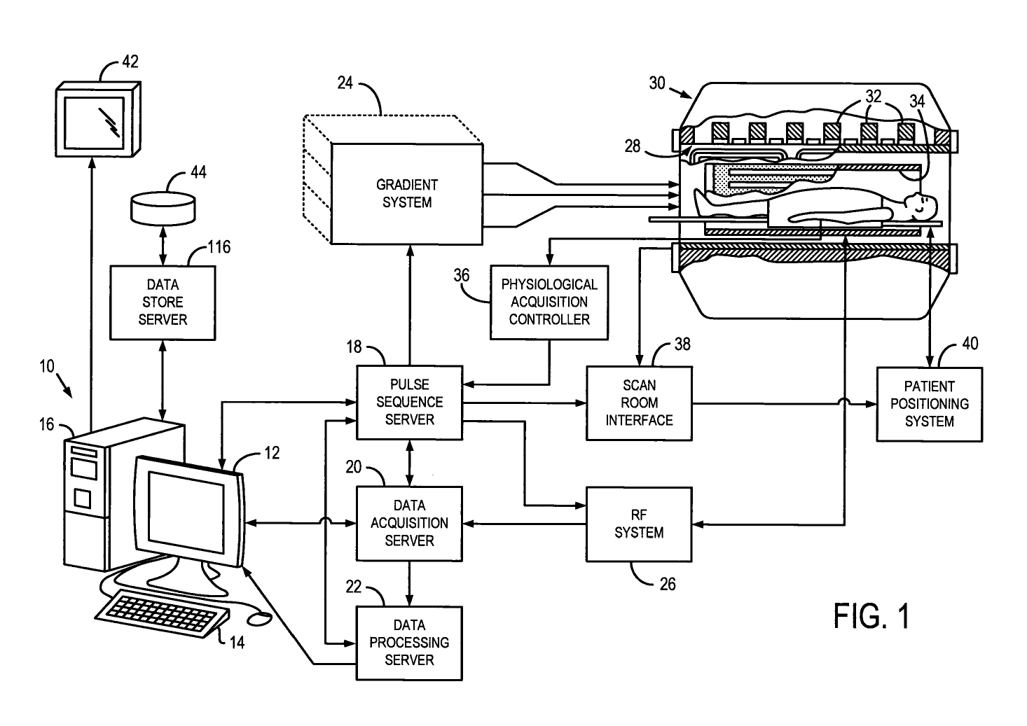

Referring particularly to FIG. 1, the invention is employed in an MRI system. The MRI system includes a workstation 10 having a display 12 and a keyboard 14. The workstation 10 includes a processor 16 that is a commercially available programmable machine running a commercially available operating system. The workstation 10 provides the operator interface that enables scan prescriptions to be entered into the MRI system.

The workstation 10 is coupled to, for example, four servers, including a pulse sequence server 18, a data acquisition server 20, a data processing server 22, and a data store server 23. In one configuration, the data store server 23 is performed by the workstation processor 16 and associated disc drive interface circuitry and the remaining three servers 18, 20, 22 are performed by separate processors mounted in a single enclosure and interconnected using a backplane bus. The pulse sequence server 18 employs a commercially available microprocessor and a commercially available communication controller. The data acquisition server 20 and data processing server 22 both employ commercially available microprocessors and the data processing server 22 further includes one or more array processors based on commercially available processors.

The workstation 10 and each processor for the servers 18, 20, 22 are connected to a communications network. This network conveys data that is downloaded to the servers 18, 20, 22 from the workstation 10 and conveys data that is communicated between the servers 18, 20, 22 and between the workstation 10 and the servers 18, 20, 22. In addition, a high speed data link is typically provided between the data processing server 22 and the workstation 10 in order to convey image data to the data store server 23.

The pulse sequence server 18 functions in response to program elements downloaded from the workstation 10 to operate a gradient system 24 and an RF system 26. Gradient waveforms necessary to perform the prescribed scan are produced and applied to the gradient system 24 that excites gradient coils in an assembly 28 to produce the magnetic field gradients Gₓ, G_{y}, and G_{z} used for position encoding NMR signals. The gradient coil assembly 28 forms part of a magnet assembly 30, which includes a polarizing magnet 32 and a whole-body RF coil 34.

The RF excitation waveforms are applied to the RF coil 34 by the RF system 26 to perform the prescribed magnetic resonance pulse sequence. Responsive NMR signals detected by the RF coil 34 are received by the RF system 26, amplified, demodulated, filtered, and digitized under direction of commands produced by the pulse sequence server 18. The RF system 26 includes an RF transmitter for producing a wide variety of RF pulses used in MR pulse sequences. The RF transmitter is responsive to the scan prescription and direction from the pulse sequence server 18 to produce RF pulses of the desired frequency, phase, and pulse amplitude waveform. The generated RF pulses may be applied to the whole body RF coil 34 or to one or more local coils or coil arrays.

The RF system 26 also includes one or more RF receiver channels. Each RF receiver channel includes an RF amplifier that amplifies the NMR signal received by the coil to which it is connected and a quadrature detector that detects and digitizes the in-phase (I) and quadrature (Q) components of the received NMR signal. The magnitude of the received NMR signal may thus be determined at any sampled point by the square root of the sum of the squares of the I and Q components.

The pulse sequence server 18 also optionally receives patient data from a physiological acquisition controller 36. The controller 36 receives signals from a number of different sensors connected to the patient, such as ECG signals from electrodes or respiratory signals from a bellows. Such signals are typically used by the pulse sequence server 18 to synchronize, or “gate”, the performance of the scan with the subject's respiration or heart beat. However, as will be described, the present invention alleviates the need for synchronizing or gating data acquisition using such system associated with the physiological acquisition controller 36, by providing an imaging-based technique that uses a labeling module that employs principles of arterial spin labeling (ASL), a signal threshold module that analyzes acquired data, and an imaging module that is triggered and coordinated based on the analysis of the threshold module.

The pulse sequence server 18 also connects to a scan room interface circuit 38 that receives signals from various sensors associated with the condition of the patient and the magnet system. It is also through the scan room interface circuit 38 that a patient positioning system 40 receives commands to move the patient to desired positions during the scan.

It should be apparent that the pulse sequence server 18 performs real-time control of MRI system elements during a scan. As a result, it is necessary that its hardware elements be operated with program instructions that are executed in a timely manner by run-time programs. The description components for a scan prescription are downloaded from the workstation 10 in the form of objects. The pulse sequence server 18 contains programs that receive these objects and converts them to objects that are employed by the run-time programs.

The digitized NMR signal samples produced by the RF system 26 are received by the data acquisition server 20. The data acquisition server 20 operates in response to description components downloaded from the workstation 10 to receive the real-time NMR data and provide buffer storage such that no data is lost by data overrun. In some scans, the data acquisition server 20 does little more than pass the acquired NMR data to the data processor server 22. However, in scans that require information derived from acquired NMR data to control the further performance of the scan, the data acquisition server 20 is programmed to produce such information and convey it to the pulse sequence server 18. For example, during prescans NMR data is acquired and used to calibrate the pulse sequence performed by the pulse sequence server 18. Also, navigator signals may be acquired during a scan and used to adjust RF or gradient system operating parameters or to control the view order in which k-space is sampled. Furthermore, the data acquisition server 20 may be employed to process NMR signals used to detect the arrival of contrast agent in an MRA scan. In all these examples the data acquisition server 20 acquires NMR data and processes it in real-time to produce information that is used to control the scan.

The data processing server 22 receives NMR data from the data acquisition server 20 and processes it in accordance with description components downloaded from the workstation 10. Such processing may include, for example, Fourier transformation of raw k-space NMR data to produce two or three-dimensional images, the application of filters to a reconstructed image, the performance of a backprojection image reconstruction of acquired NMR data, the calculation of functional MR images, the calculation of motion or flow images, and the like.

Images reconstructed by the data processing server 22 are conveyed back to the workstation 10 where they are stored. Real-time images are stored in a data base memory cache (not shown) from which they may be output to operator display 12 or a display 42 that is located near the magnet assembly 30 for use by attending physicians. Batch mode images or selected real time images are stored in a host database on disc storage 44. When such images have been reconstructed and transferred to storage, the data processing server 22 notifies the data store server 23 on the workstation 10. The workstation 10 may be used by an operator to archive the images, produce films, or send the images via a network to other facilities.

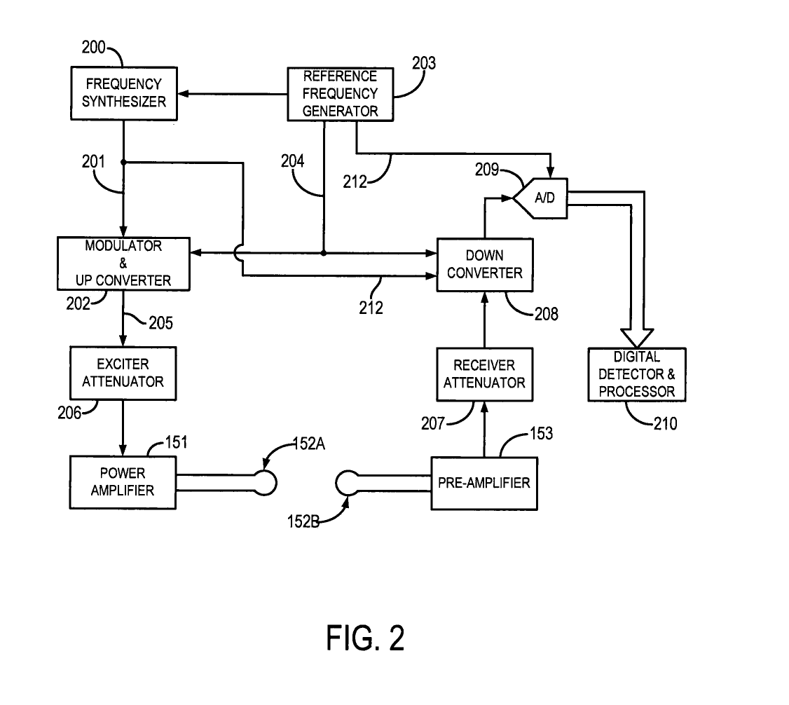

As shown in FIG. 1, the RF system 26 may be connected to the whole body RF coil 34, or as shown in FIG. 2, a transmitter section of the RF system 26 may connect to one RF coil 151A and its receiver section may connect to a separate RF receive coil 151B. Often, the transmitter section is connected to the whole body RF coil 34 and each receiver section is connected to a separate local coil 151B.

Referring particularly to FIG. 2, the RF system 26 includes a transmitter that produces a prescribed RF excitation field. The base, or carrier, frequency of this RF excitation field is produced under control of a frequency synthesizer 200 that receives a set of digital signals from the pulse sequence server 18. These digital signals indicate the frequency and phase of the RF carrier signal produced at an output 201. The RF carrier is applied to a modulator and up converter 202 where its amplitude is modulated in response to a signal R(t) also received from the pulse sequence server 18. The signal R(t) defines the envelope of the RF excitation pulse to be produced and is produced by sequentially reading out a series of stored digital values. These stored digital values may, be changed to enable any desired RF pulse envelope to be produced.

The magnitude of the RF excitation pulse produced at output 205 is attenuated by an exciter attenuator circuit 206 that receives a digital command from the pulse sequence server 18. The attenuated RF excitation pulses are applied to the power amplifier 151 that drives the RF coil 151A.

Referring still to FIG. 2, the signal produced by the subject is received by the receiver coil 152B and applied through a preamplifier 153 to the input of a receiver attenuator 207. The receiver attenuator 207 further amplifies the signal by an amount determined by a digital attenuation signal received from the pulse sequence server 18. The received signal is at or around the Larmor frequency, and this high frequency signal is down converted in a two step process by a down converter 208 that first mixes the NMR signal with the carrier signal on line 201 and then mixes the resulting difference signal with a reference signal on line 204. The down converted NMR signal is applied to the input of an analog-to-digital (ND) converter 209 that samples and digitizes the analog signal and applies it to a digital detector and signal processor 210 to produce the I values and Q values corresponding to the received signal. As described above, the resulting stream of digitized I and Q values of the received signal are output to the data acquisition server 20 of FIG. 1. The reference signal, as well as the sampling signal applied to the ND converter 209, is produced by a reference frequency generator 203.

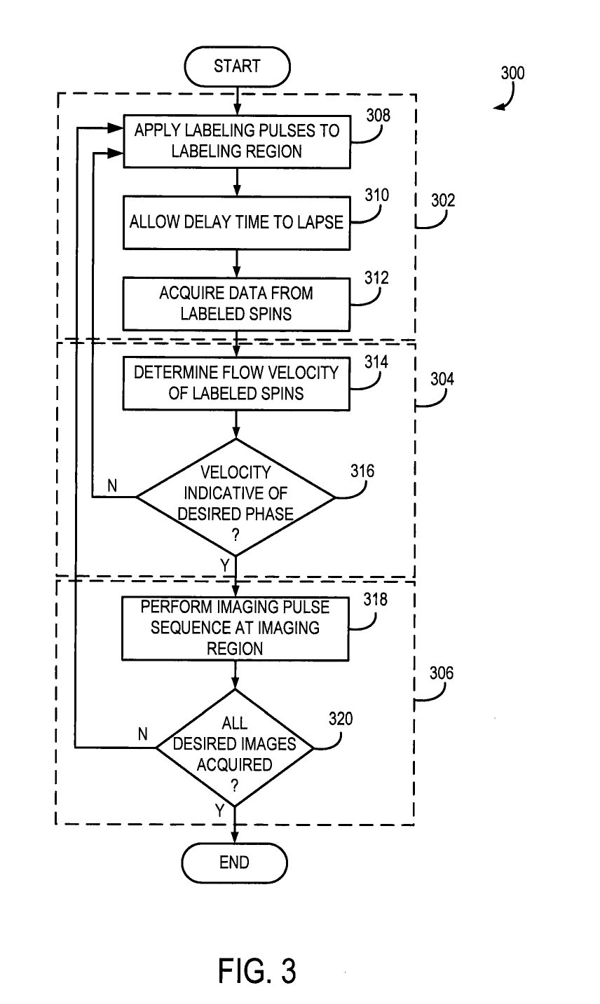

As mentioned, the present invention alleviates the need for synchronizing or gating the data acquisition using such a system associated with the physiological acquisition controller or the need to rely on so-called self-gating techniques based upon navigator images of the heart or using phase-contrast techniques. Referring to FIG. 3, a method 300 in accordance with the present invention can be conceptualized as including a labeling module 302 that employs the principles of arterial spin labeling (ASL), a signal threshold module 304 that analyzes acquired data, and an imaging module 306 that is triggered and coordinated based on the analysis of the threshold module. The labeling module 302 includes the application of one or more labeling radio frequency (RF) pulses applied to a portion of a labeling region, as indicated at process block 308. Following a delay time indicated at process block 310, data is acquired at process block 312 from the labeled spins.

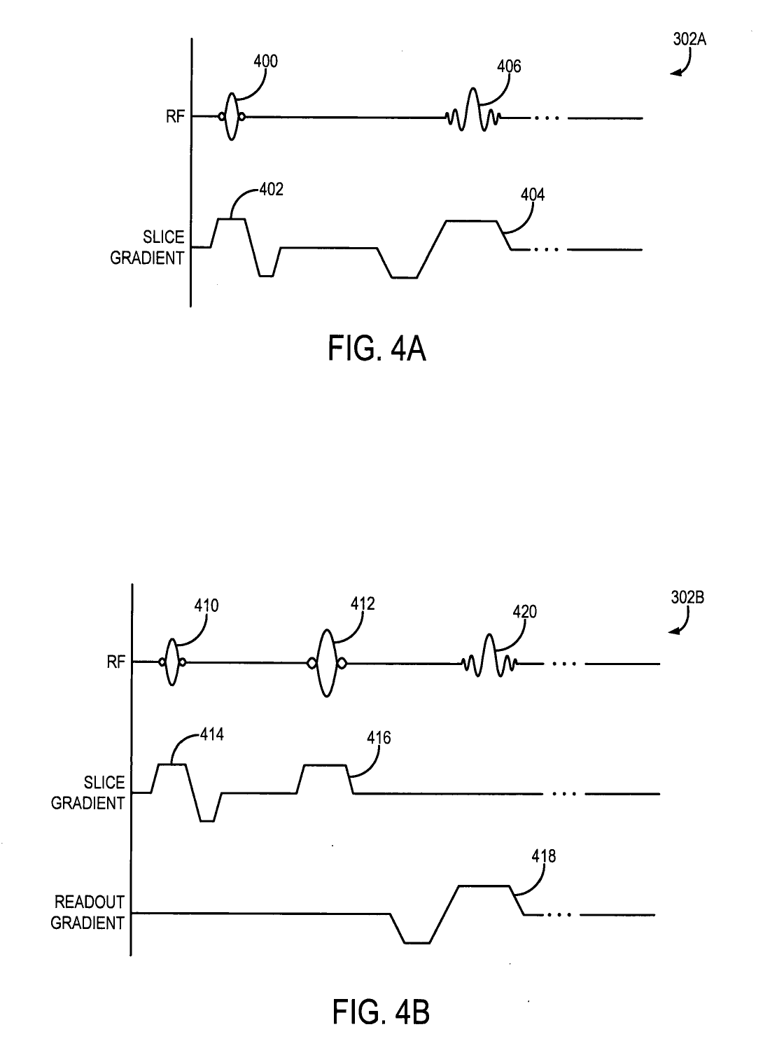

It is contemplated that a variety of pulse sequences may be employed for labeling and acquisition. For example, a variety of ASL-based and ASL-like techniques can be used in the labeling module 302, including those based upon gradient-echo and spin-echo pulse sequences. Specifically, referring to FIGS. 4A and 4B two such example pulse sequence diagrams are provided.

In FIG. 4A a gradient-echo, ASL labeling module 302A is illustrated that includes a single 90 degree RF excitation pulse 400 applied to a “labeling region,” for example, axial slice, and signal readout gradients 402, 404, for example, arranged in the head-to-foot direction. No phase-encoding gradient is illustrated in FIG. 4A so that a time-resolved, one dimensional (1D) set of data can be rapidly acquired. By orienting the readout gradient 404 orthogonal to the orientation of the labeling region, signals in the acquired echoes 406 corresponding to labeled arterial spins that have flowed downstream in the arteries can be readily distinguished from those arising from stationary tissues and veins within the labeling region.

In FIG. 4B a spin-echo ASL labeling module 302B is illustrated that includes a 90 degree RF excitation pulse 410 and a 180 degree refocusing RF pulse 412 that is applied to a “refocusing region” downstream from the labeling region. Also, it is contemplated that refocusing RF pulse 412 may be applied to a “refocusing region” that is tilted with respect to the labeling region so that the regions intersect. In this arrangement, an “inner volume” is created by the overlapping labeling and refocusing region where only arterial spins that are labeled within the volume of intersection between the regions will produce detectable signals.

In the illustrated example, it is contemplated that the slice select gradients 414, 416 and readout gradient 418 are arranged with respect to the excitation pulse 410 in a right-to-left orientation. As a consequence, spin-echo signals 420 are generated from labeled arterial spins that have flowed downstream through the arteries, but not from stationary tissues and veins within the labeling region. Note that more than one refocusing RF pulse can be applied at user-selected (even arbitrary) positions within the labeling region to generate additional labeling signals.

If desired, a head-to-foot orientation of the readout gradient 418 instead of the right-to-left orientation could have been used as described above with respect to FIG. 4A. Also, a fast phase-encoding technique, such as spiral, echo planar, undersampled radial, Cartesian using high parallel acceleration factor, or the like) may be used to generate a time-resolved, two-dimensional (2D) set of data.

Returning to FIG. 3, once a time-resolved series of MR signals has been acquired from the spins passing through the labeling region and labeled by the labeling module 302, the signal threshold module analyses these MR signals on the fly to determine the flow velocity of the labeled spins at process block 314 and compares this flow velocity to a desired threshold or thresholds corresponding to one or more of the cardiac phases at decision block 316. For example, the detected flow velocity of the spins moving within the labeling region to a predetermined metric. This metric comparison is then used to determine when the subject is in a predetermined cardiac phase.

There are several options for determining the metric or desired threshold or thresholds. For instance, one can set a velocity threshold above an expected maximal diastolic flow velocity, for example, such as 30 cm/sec for arteries of the legs. Thus, in this example, a labeling data set having a velocity exceeding this threshold would indicate the onset of a systolic cardiac phase. However, the desired threshold(s) may depend on the arterial system, patient parameters (such as age, vascular conditions, and the like), and non-patient condition (scanning protocols, system constraints, and the like). Alternatively or additionally, the desired velocity threshold(s) may be determined in successive sets of labeling data, for example, such as 20 cm/s and 40 cm/s. A velocity increase in two successive labeling data sets indicates flow acceleration and, thus, the onset of a systolic cardiac phase.

Once the desired portion of the cardiac phase is identified from the velocity at decision block 316, the image module 306 performs the desired imaging pulse sequence at process block 318. Specifically, it is noted that the imaging region is separate from, and does not overlap with, the labeling region. This process is repeated until, at decision block 320, all desired images have been acquired.

The above-described methods and processes may be varied based on clinical application. For example, flow compensation may be used to reduce or eliminate flow-related phase shifts. Further still, a time delay may be employed between the trigger module and initiation of the imaging pulse sequence of the imaging module to image during an arbitrary phase of the cardiac cycle.

The present invention provides systems and methods that do not require the application of external leads or other devices to perform cardiac gating. Accordingly, patient comfort is improved and setup time is reduced. The techniques of the present invention are not affected by electromagnetic interference and are, therefore, more reliable than ECG gating, especially at high magnetic field strengths. Furthermore, the present invention is less sensitive to arrhythmias than ECG gating since the trigger signal is predicated on the presence of accelerating blood flow, which is directly representative of the onset of systole, rather than to an electrical signal.

The present invention has been described in terms of one or more preferred embodiments, and it should be appreciated that many equivalents, alternatives, variations, and modifications, aside from those expressly stated, are possible and within the scope of the invention.

1. A method acquiring a magnetic resonance angiography (MRA) image of a portion of a vasculature of a subject using a magnetic resonance imaging system, the method comprising:
applying a labeling pulse sequence to a labeling region of a subject having a first portion of a vasculature extending through the labeling region to label spins moving within the labeling region;
acquiring labeling data from the labeled spins;
analyzing the labeling data to determine a velocity of the labeled spins moving within the subject;
comparing the velocity of the labeled spins to a predetermined metric;
based on the comparison of the velocity of the labeled spins to the predetermine metric, determining the subject is in a predetermined cardiac phase;
when the subject is in the predetermined cardiac phase, applying an imaging pulse sequence to an imaging region of the subject having a second portion of the vasculature extending through the imaging region, wherein the imaging region is separate from labeling region;
acquiring medical imaging data from the imaging region of the subject; and
reconstructing an image of the second portion of the vasculature from the medical imaging data.

2. The method of claim 1 wherein the labeling pulse sequence includes a refocusing pulse applied to a refocusing region.

3. The method of claim 2 wherein at least one refocusing region is proximate to the labeling region.

4. The method of claim 3 wherein at least one of the at least one refocusing region is tilted in orientation with respect to the labeling region and intersects therewith.

5. The method of claim 1 wherein at least one of the labeling pulse sequence and the imaging pulse sequence include a gradient-echo pulse sequence

6. The method of claim 1 wherein at least one of the labeling pulse sequence and the imaging pulse sequence include a spin-echo pulse sequence.

7. The method of claim 1 wherein the labeling region and the imaging region are located in a peripheral vasculature of the subject.

8. The method of claim 1 wherein the labeling region and the imaging region include an aorta of the subject.

9. A non-transitive computer readable store medium having stored thereon a set of instructions that, when executed by a computer system, cause the computer system to:
apply a labeling pulse sequence to a labeling region of a subject having a first portion of a vasculature to label spins moving within the labeling region;
acquire labeling data from the labeled spins;
analyze the labeling data to determine a velocity of the labeled spins moving in the subject;
compare the velocity of the labeled spins to a predetermined metric;
based on the comparison of the velocity of the labeled spins to the predetermine metric, determine a cardiac phase of the subject;
when the cardiac phase of the subject is a predetermined cardiac phase, apply an imaging pulse sequence to an imaging region of the subject having a second portion of the vasculature extending therein, wherein the imaging region is separate from labeling region;
acquire medical imaging data from the imaging region of the subject; and
reconstruct an image of the second portion of the vasculature from the medical imaging data.

10. The non-transitive computer readable store medium of claim 9 wherein the labeling pulse sequence includes a refocusing pulse applied to a refocusing region.

11. The non-transitive computer readable store medium of claim 10 wherein refocusing region is proximate to the labeling region.

12. The non-transitive computer readable store medium of claim 11 wherein the refocusing region is tilted in orientation with respect to the labeling region and intersects therewith.

13. The non-transitive computer readable store medium of claim 9 wherein at least one of the labeling pulse sequence and the imaging pulse sequence includes one of a gradient-echo pulse sequence and a spin-echo pulse sequence.

14. A magnetic resonance imaging (MRI) system comprising:
a magnet system configured to generate a polarizing magnetic field about at least a portion of a subject arranged in the MRI system;
a plurality of gradient coils configured to apply a gradient field to the polarizing magnetic field;
a radio frequency (RF) system configured to apply an excitation field to the subject and acquire MR image data therefrom;
a computer system programmed to:
control the RF system and gradient coils according to a labeling module to perform a labeling pulse sequence to label moving spins in a first portion of a vasculature of a subject and acquire labeling data from at least one of the first portion of the vasculature of the subject and a portion of the vasculature of the subject proximate to the first portion of the vasculature of the subject;
operate according to a threshold module to analyze the labeling data to determine a velocity of the moving spins, compare the velocity of the moving spins to a predetermined metric and, based on the comparison of the velocity of the moving spins to the predetermine metric, generate a trigger signal upon determining the subject is in a predetermined cardiac phase;
control the RF system and gradient coils, in response to the trigger signal, according to an imaging module to perform an imaging pulse sequence and acquire medical imaging data from a second portion of the vasculature of the subject that is separate from the first portion of the vasculature; and
reconstruct an image of the second portion of the vasculature from the medical imaging data.

15. The MRI system of claim 14 wherein the labeling pulse sequence includes a refocusing pulse applied to a refocusing region.

16. The MRI system of claim 15 wherein refocusing region is tilted in orientation with respect to the labeling region and intersects therewith.

17. The MRI system of claim 14 wherein at least one of the labeling pulse sequence and the imaging pulse sequence includes one of a gradient-echo pulse sequence and a spin-echo pulse sequence.
